(19) United States
(12) Patent Application Publication
(10) Pub. No.: US 2010/0085321 A1
(43) Pub. Date: Apr. 8, 2010

(54) SMALL TOUCH SENSITIVE INTERFACE ALLOWING SELECTION OF MULTIPLE FUNCTIONS

(76) Inventor: Mark Stephen Pundsack, San Francisco, CA (US)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/572,907

(22) Filed: Oct. 2, 2009

Related U.S. Application Data
(60) Provisional application No. 61/102,508, filed on Oct. 3, 2008.

(51) Int. Cl. G06F 3/041

(52) U.S. Cl. 345/173

(57) ABSTRACT

An interface or control device having one or more sensors and a barrier wherein the one or more sensors are arranged relative to the barrier to be able to detect touch or proximity of a finger on each of two opposite sides of the barrier, the barrier inhibits or provides a touch sensory indication of simultaneous touch or proximity of the finger to sensors or parts of the sensor on opposite sides of the barrier, and the size of the device is such that a finger could simultaneously touch or be near sensors or parts of a sensor on opposite sides of the device in normal use if the barrier were not present.

This application claims the benefit of U.S. Provisional Application No. 61/102,508 filed on Oct. 3, 2008, which is incorporated herein in its entirety by this reference to it.

### FIELD

This invention relates to control devices or interfaces allowing a user to instruct a device to perform a desired function, for example touch sensitive interfaces for controlling electronic devices.

### BACKGROUND

Touch sensitive interfaces have been in use in consumer electronics. For example, the iPod™ uses a capacitance-based touch sensor in the shape of a planar circular ring laid on top of physical buttons. The ring shape allows a user to rotate around the ring for such tasks as changing volume or scrolling through a long list of songs. Touch sensitive rings must have an outer diameter of at least 1″ (25 mm). The size of the design is limited by the accuracy of the capacitance sensing technology, as well as the size and accuracy of the human finger. If the outer diameter of the ring were smaller, it would be difficult for the user to pinpoint a specific position on the interface and the finger would make contact with multiple sensor pads at the same time.

### Introduction

The following introduction is intended to introduce the reader to the more detailed description that follows, and not to define or limit the invention.

Interfaces or remote controls allow a user to select or instruct a controlled device to perform one or more functions. An interface may be separate or detached from the controlled device (as in a computer mouse) or incorporated into the controlled device (as in a control on the surface of a laptop computer or music or video fie player). The interface may also appear in a mixed configuration, for example the interface may be located on an audio headset that is operatively (or even physically) connected to a controlled telephone, computer or music or video file player. This last example is of particular concern to the inventor since, in addition to general difficulties in the design of controlled devices, headsets may provide only very small or curved surfaces on which to mount the controls and the user is not able to see the control while using it. Further, a headset may be required to facilitate the control of many functions. For example, the inventor (with others) described a headset that allowed a user to control a telephone and a computer or other device playing music files in U.S. patent application Ser. No. 11/322,730 filed on Dec. 30, 2005. That application is incorporated herein in its entirety by this reference to it.

The interface designs described below are very small, for example having an outer diameter of the larger of a barrier and an arrangement of one or more sensors of 20 mm or less or 15 mm or less or 10 mm or less. At least some of the designs can also be used with a device holding the interface when the surface of the device surrounding the interface is curved, either in convex or concave curvature. The interface designs described below have a physical barrier such as a button, dome, cylinder, bubble, truncated cone, or other shape. The centre of the barrier is generally vertically aligned with the centre of one or more sensors, for example by being inside of or covering a ring of sensors. The one or more sensors may be located, for example, within a flat annular ring or on the sides of a truncated cone, a dome or a hemi-sphere.

To allow the user to select a desired function, contact with an individual sensor or distinguishable sensor area can be mapped to a desired function. Further, various possible sequences of contact with the different sensors or areas can be mapped to functions. If desired, a sensor can be optionally added in the centre of the one or more sensors with contact with this central sensor mapped to a function or incorporated into additional touch sequences. Further optionally, an assembly of the one or more sensors and barrier may be mounted over another sensor or switch such that pressing on the assembly produces a signal that may be used to control a desired function. As examples of movements that can be mapped to functions, a user can move a finger across the barrier backwards, forwards, up or down; tap, click or hold a particular sensor or switch; or, rotate a finger around the barrier. In each of these cases, a different sequence of touches to one or more sensors is produced.

When the user is making movements such as those described above, the barrier inhibits simultaneous contact or proximity of the user's finger with sensors or sensor areas on opposite sides of the barrier, or at least provides an indication through sense of touch that helps the user avoid such simultaneous contact. The barrier also provides a tactile reference point for the user to more accurately control the contact. For example, the barrier may help the user locate a specific desired sensor or help the user distinguish movement from one side of the ring of sensors to the other side through the centre of the ring from movement around the circumference of the ring. In a movement from one side to the other through the centre, the barrier moves the user's finger away from sensors in the ring that, if touched, could give an undesired signal. In a rotational movement, the barrier is instrumental in allowing the user to move their finger in an accurately placed small circular motion. These aspects of the interface are useful in many applications, particularly if a small interface is desired, and become even more important in situations where the user can not see the interface. In those cases, the barrier additionally helps the user find the interface on the surface of a device holding it.

In various examples, a touch sensitive sensor mechanism such as a capacitance sensor or light-touch pressure sensor (“sensor pad”) is shaped as a segmented ring. The diameter of the segmented ring is small, for example 10 mm to 20 mm. A physical barrier is provided in the center of the sensor mechanism. The barrier isolates the sensor pads so that only a limited number, usually 1-2, can be activated at any time. The barrier provides a physical reference for the user to rotate a finger around. The device may be used for example as a user interface for wired or wireless earbuds to control audio playback, a user interface for a computer mouse, a user interface for an audio remote control. The barrier may be in the form of a button, dome; bubble, cone, or other shape. Sensors may be located inside the barrier. Alternately, there may be a touch sensitive area around a button. When a finger is on one side of button, contact is isolated to sensor pads on that side. Software is used to analyze the sensor signals to interpret the user's movement and intent. The device can sense rotation of a finger around the center of the barrier. The device can also sense finger swipe from one side of the button to the other by detecting contact or proximity to the sensor(s) on the one side, followed by contact or proximity to the sensor(s) on the other side. By using multiple sensor segments around the edge of the button, multiple directions can be detected. Four quadrants can be used to detect swipes from left to right, right to left, top to bottom, and bottom to top. More sensor segments can improve accuracy of detection or detection of different angles of swiping if desired. The same sensor pads can be used to detect rotation of the finger around the button in either clockwise or counter clockwise directions. The device can detect tapping or tap-and-hold of the center button if an additional sensor is placed in the center of the button. Parts of the device can be mounted over a physical switch to provide tactile response for the center button and detection of physical pressure when user's finger is gloved or otherwise would not trigger a capacitance sensor.

### BRIEF DESCRIPTION OF FIGURES

FIG. 1 shows an isometric view of a first remote control interface, the first interface having a domed physical barrier over flat surface.

FIG. 2 shows the first interface as shown in FIG. 1 drawn as if the barrier is transparent to show a group of sensors embedded below the barrier.

FIG. 3 shows the first interface as shown in FIG. 1 with a user's finger over the barrier proximal to one or more sensors underneath the barrier.

FIG. 4 shows a perspective end view of the first interface with a user's finger making contact with one side of the barrier, without making contact with the opposite side of the barrier, thus only triggering one or more sensors on one side of the group of sensors.

FIG. 5 shows an exploded view of the first interface as shown in

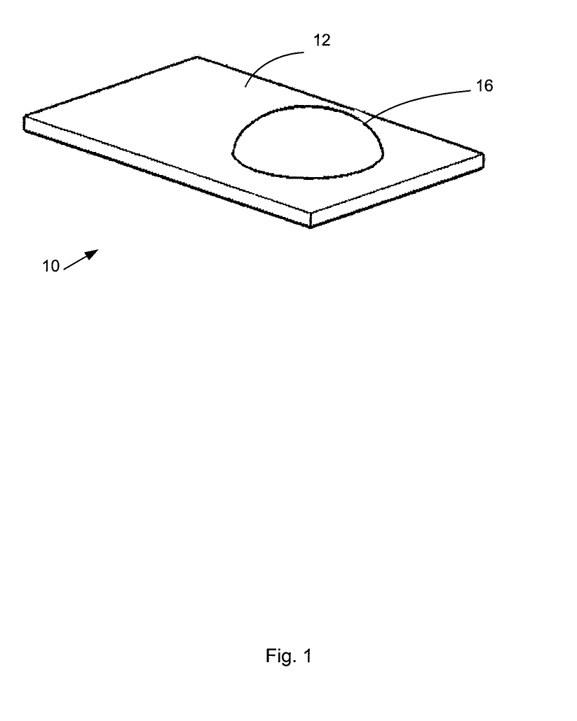

FIG. 1, showing a group of sensors forming a cone to fit inside of the barrier which has a cone shaped underside and a dome-shaped topside.

FIG. 6 is a cross-sectional exploded view of the first interface as shown in FIG. 1 showing the group of sensors embedded inside of a plastic button which acts as the barrier.

FIG. 7 is a top view of the first interface drawn as if the barrier is transparent to show the sensors, with a user's finger making contact with an individual sensor in a segmented group of sensors.

FIG. 8 is a top view of the first interface drawn as if the barrier is transparent to show the sensors, with a user's finger activating two adjacent sensors and the location of the user's finger interpolated as being between the two adjacent sensors.

FIG. 9 is an isometric view of the first interface as shown in FIG. 1, with a user's finger rotating around the barrier and triggering a succession of sensor activations.

FIG. 10 is an isometric view of the first interface showing a swiping motion that could be made with a user's finger from one side of the barrier to the other side of the barrier via the top of the barrier instead of rotating around the barrier's outer edge.

FIG. 11 is an isometric view of a second remote control interface using a segmented ring around a raised center barrier below a ring shaped touch surface drawn as if the touch surface is transparent.

FIG. 12 is an isometric exploded view of the second interface.

FIG. 13 is an isometric view of the second interface as shown in FIG. 11 with a user's finger activating a sensor of the sensor ring on one side of the center barrier.

FIG. 14 is an end view of the second interface with a user's finger as in FIG. 13 showing the center barrier blocking the user's finger from crossing to the other side of the barrier.

FIG. 15 shows a top view of a third remote control interface drawn as if a touch surface is transparent.

FIG. 16 is a top view of a segmented sensor ring, comprising a sensor mount and sensors, of the third interface.

FIG. 17 shows a side view of the sensor ring shown in FIG. 16.

FIG. 18 is a top view of the touch surface of the third interface.

FIG. 19 is a side view of a central physical barrier of the third interface.

FIG. 20 is a side view of the assembled third interface.

FIG. 21 is an exploded isometric view of a fourth remote control interface having a segmented sensor ring and a center button.

FIG. 22 is shows a remote control interface similar to that of FIGS. 1 to 10 but with a concave surface around the barrier installed in a headset.

### DETAILED DESCRIPTION

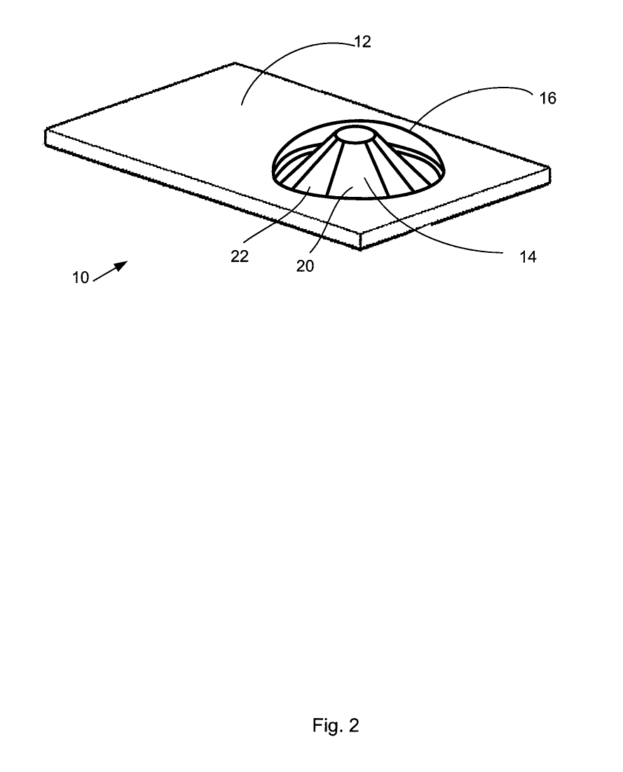

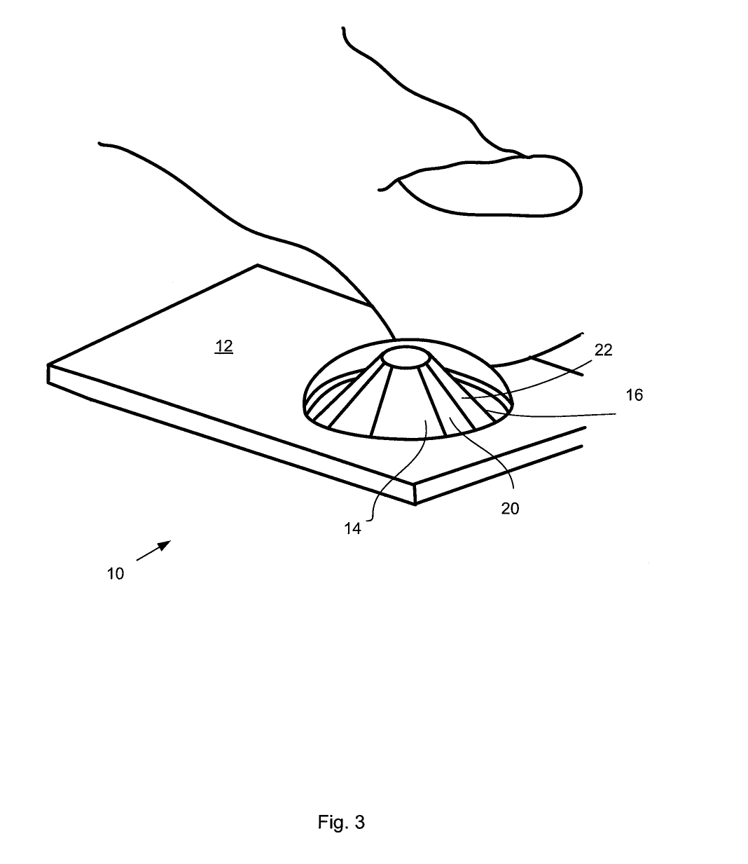

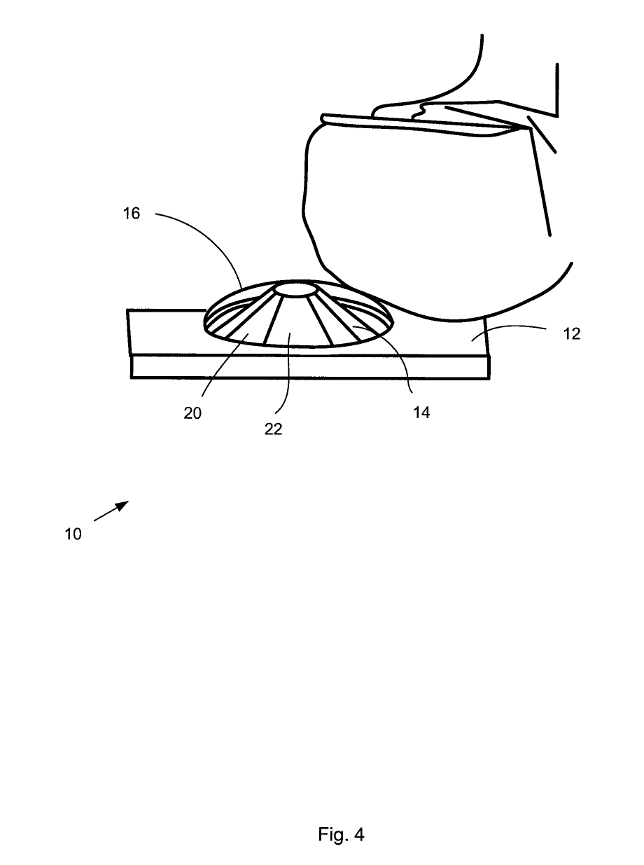

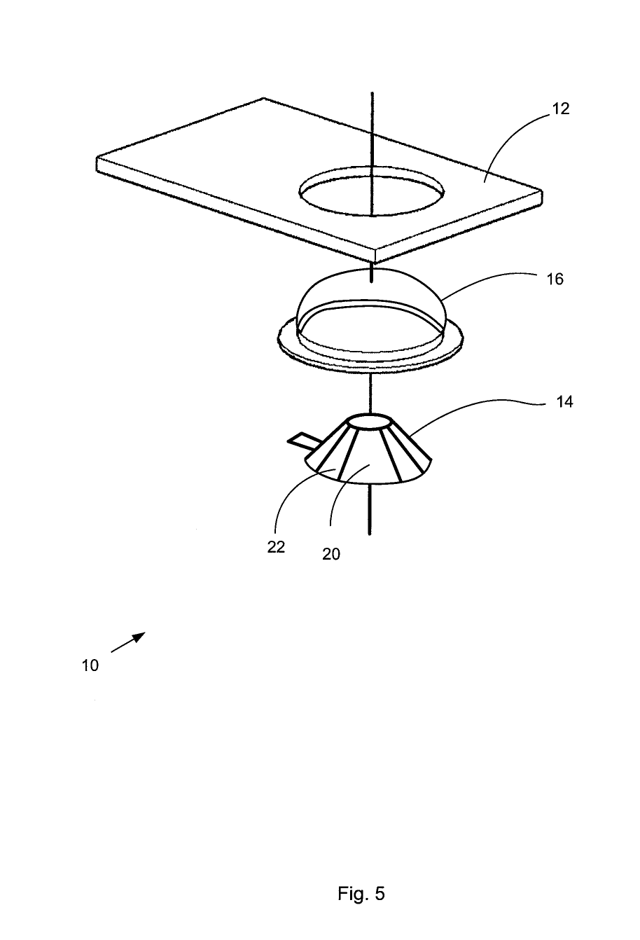

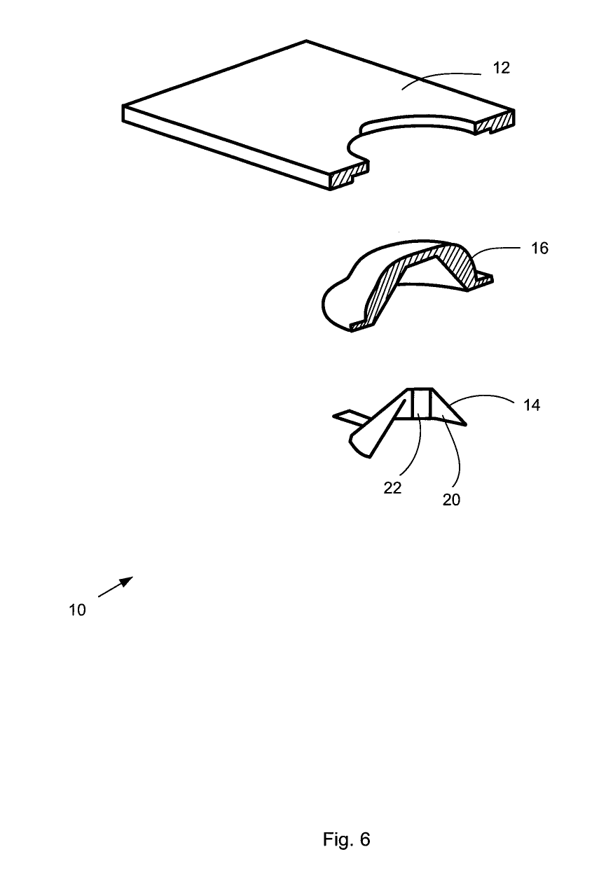

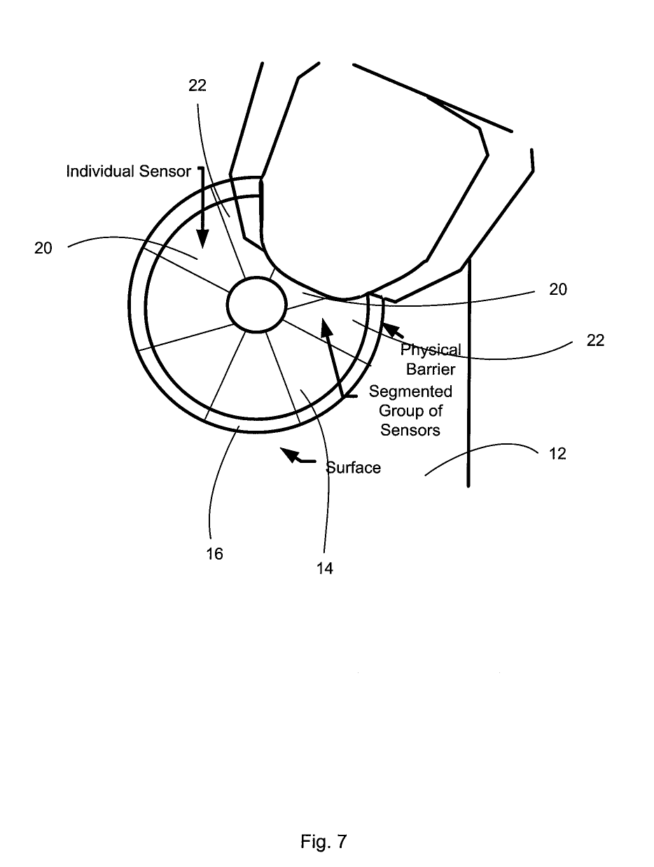

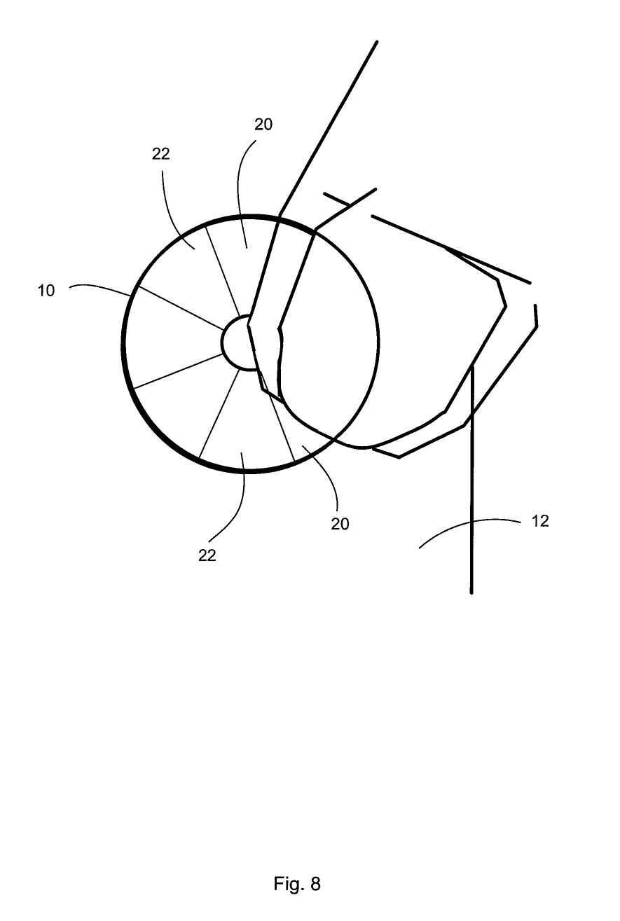

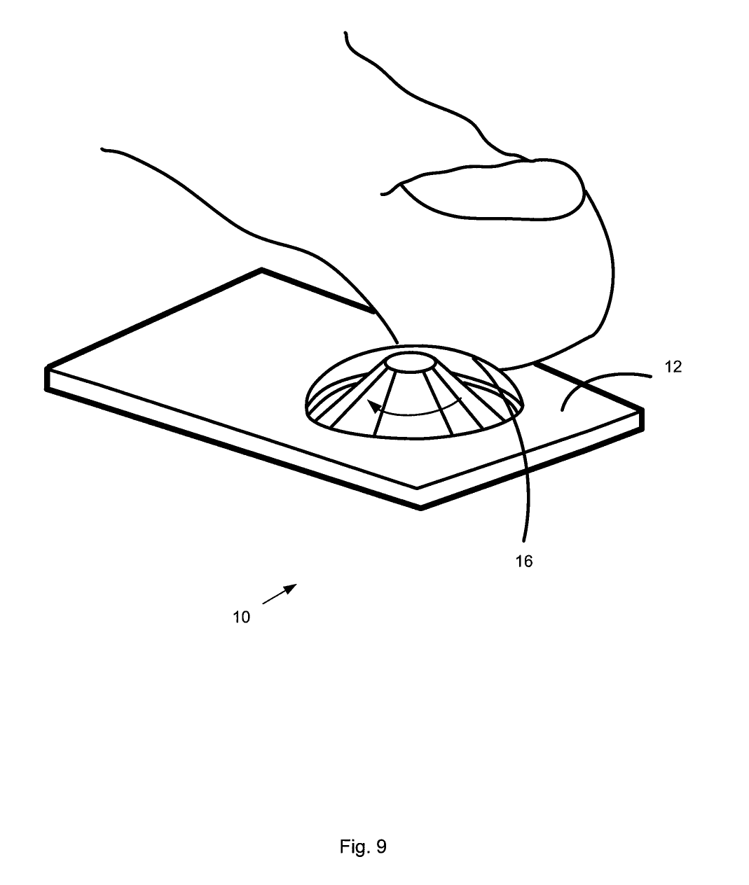

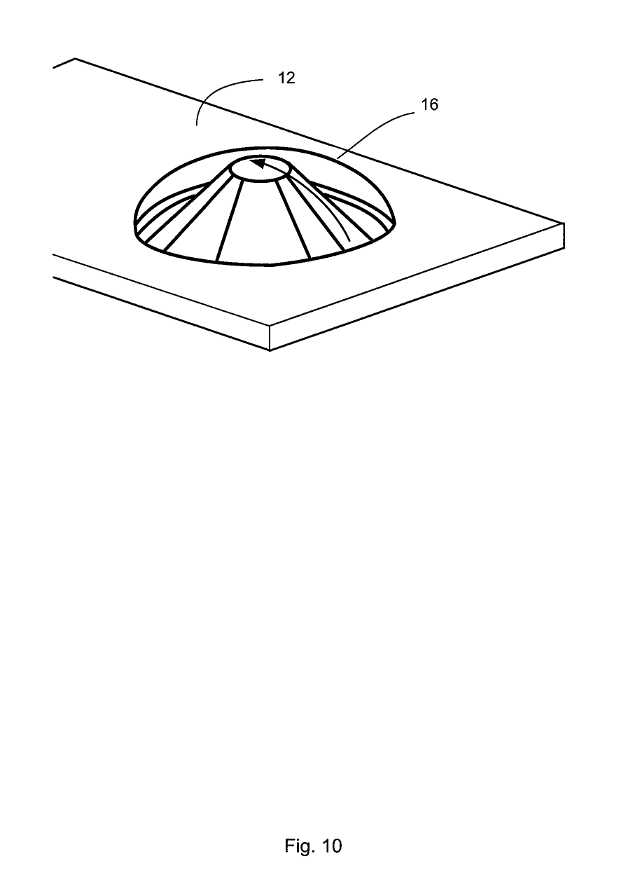

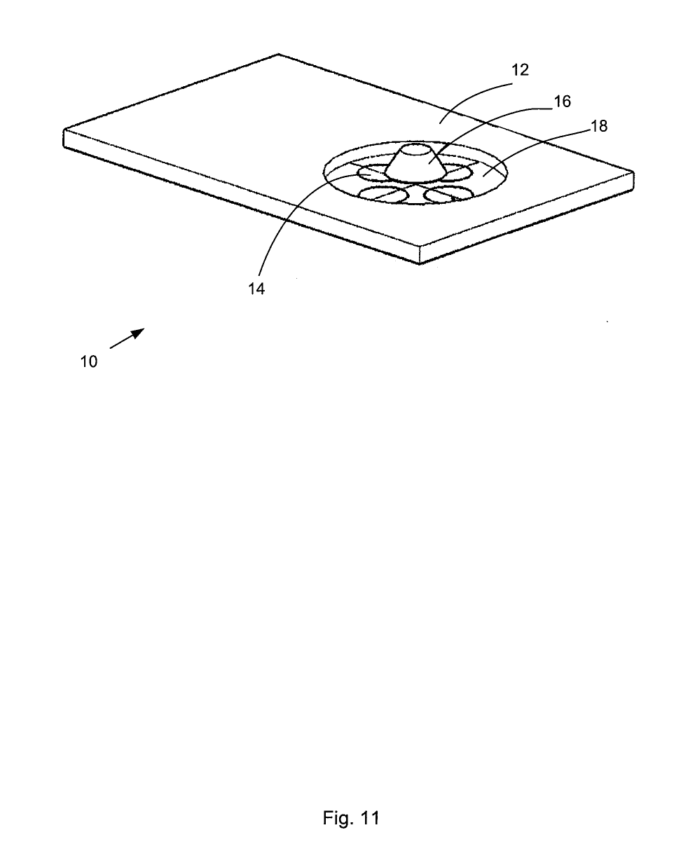

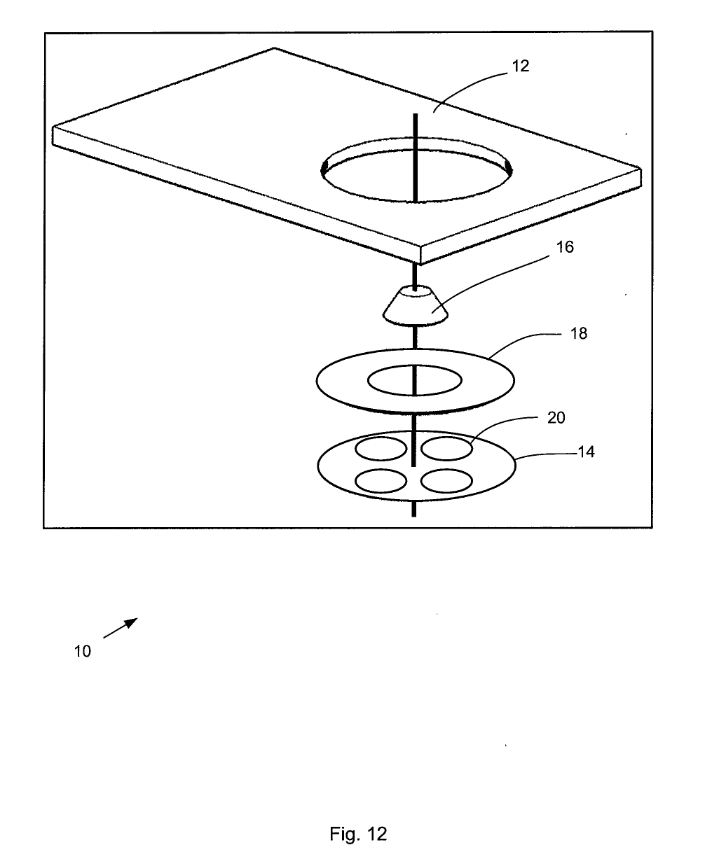

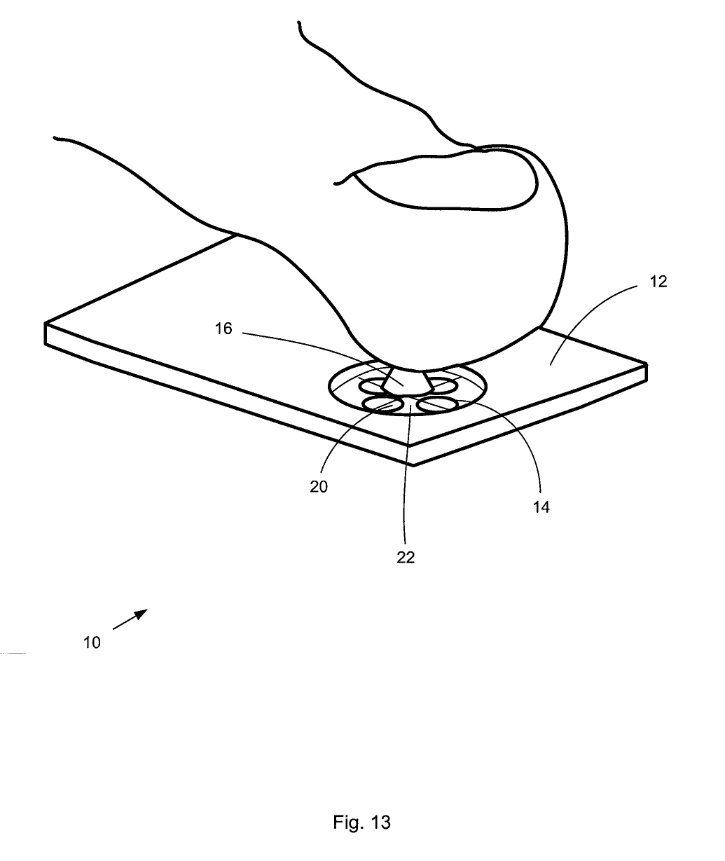

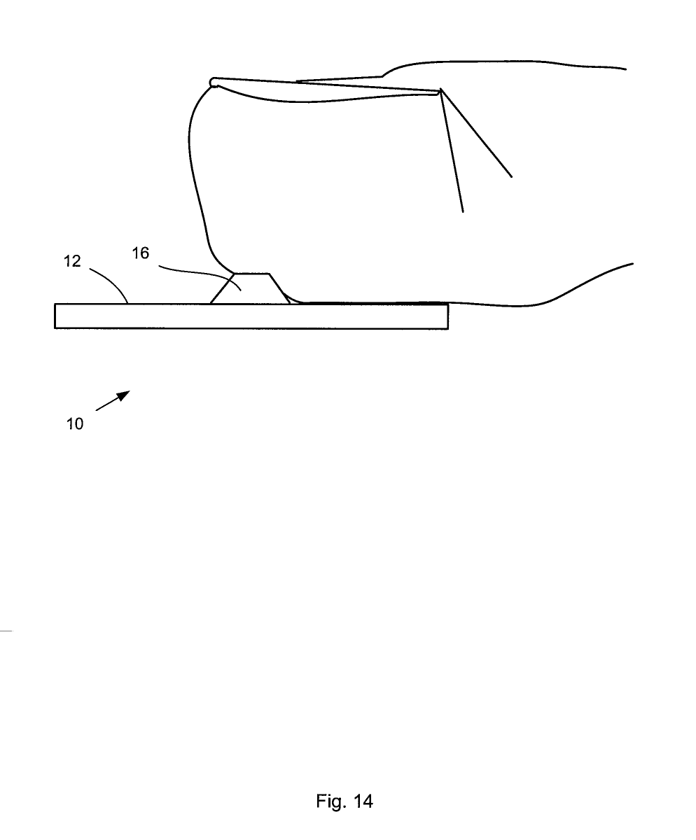

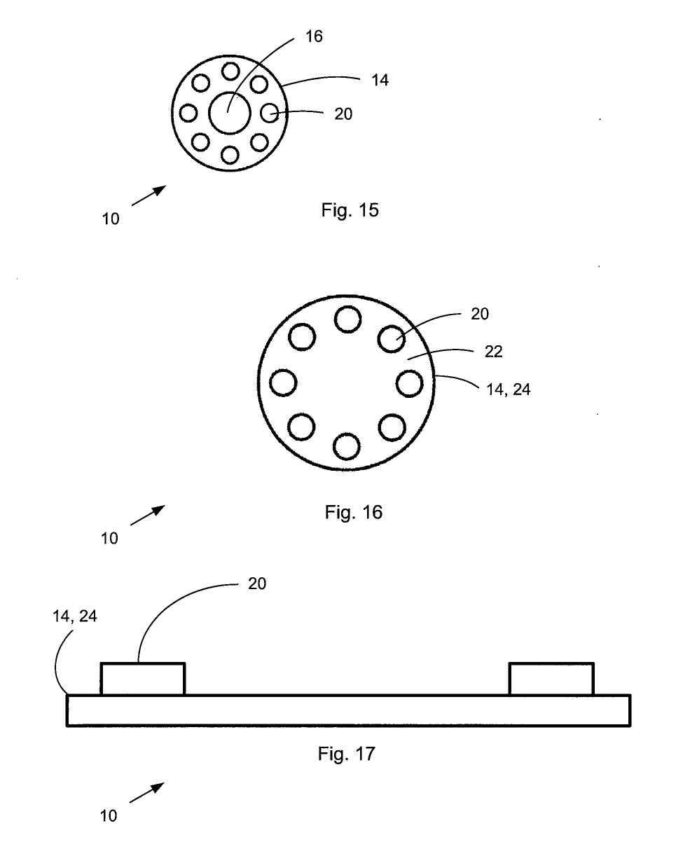

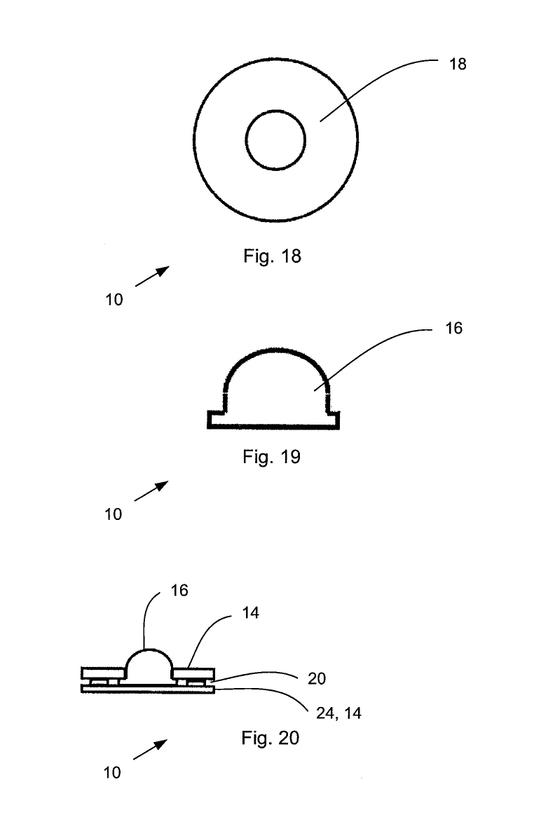

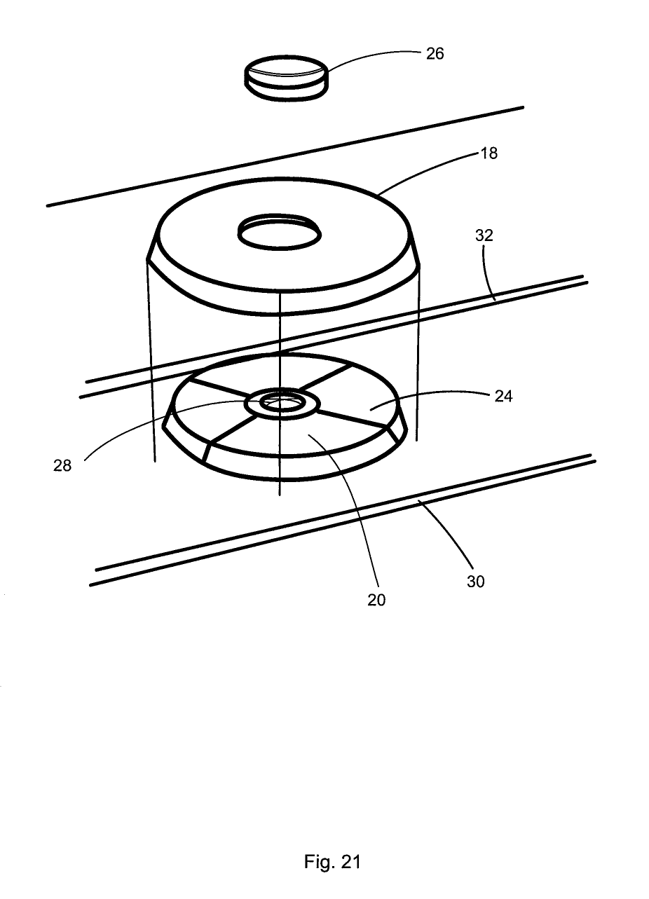

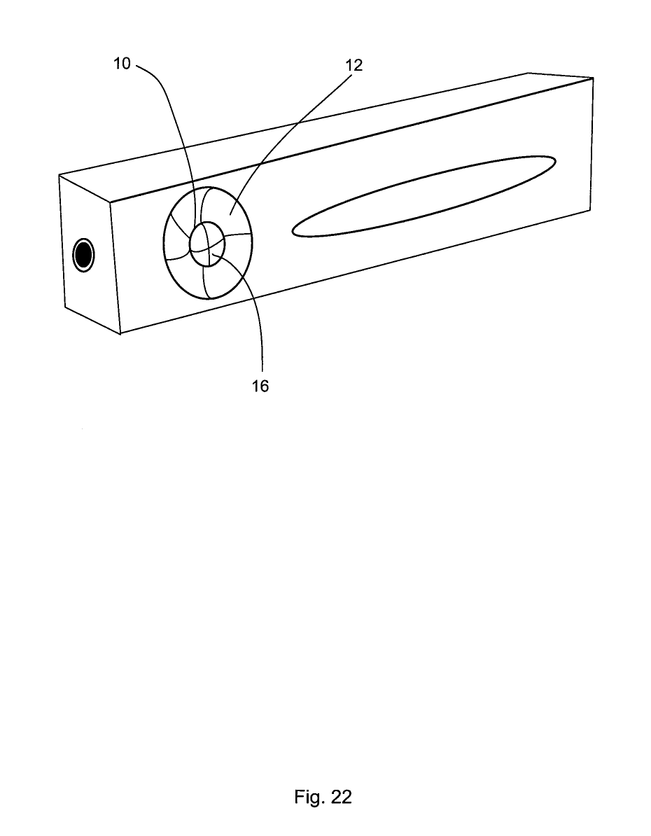

Referring to the figures, an interface 10 has a surface 12, a sensor or group of sensors (to be referred to as “sensors 14” herein for brevity), and a physical barrier 16. (See for example FIG. 1, FIG. 2, and FIG. 11). The sensors 14 and barrier 16 are generally centered on or around a shared notional axis that extends out from the surface 12, the axis typically 4 being roughly normal to the surface 12. The sensors 14 detect contact with or proximity of the user's finger. The sensors 14 may be embedded in or placed under the barrier 16 itself (see for example FIG. 5); around and proximal to the barrier 16 (see for example FIG. 12); or, both in the sense that the sensors 14 may be embedded in or under a part of a barrier 16 that is located around and proximal to another part of the barrier 16 (see for example FIG. 21). The barrier 16 is sized and raised above the adjacent part of the surface or the sensor assembly to an extent that it enables the user to sense by touch, and so avoid, having the user's finger simultaneously contact radially and circumferentially opposed sides (sensors or parts of a sensor located at 180 degrees of rotation around the centre of the barrier 16 from each other) of the interface axis. (See for example FIG. 3, FIG. 4, FIG. 13, and FIG. 14). The barrier 16 may further make it physically difficult for the user's finger to make such simultaneous contact. A barrier 16 that provides physical interference inhibiting touch or proximity to opposed sides of the barrier may however allow the user to have contact or proximity with one sensor or simultaneous contact or proximity with two circumferentially adjacent sensors. (See for example FIGS. 7 and 8).

The surface 12 may be flat, although it could be rounded or otherwise shaped. The surface 12 may also be mounted below or integrated with the casing of a device that holds the interface 10. Accordingly, the larger in diameter of the barrier 16 and the sensors 14 (that is, the largest part of the interface other than the surface) controls the nominal outer diameter of the interface, which may be 20 mm or less or 15 mm or less or 10 mm or less. Alternately or additionally, the part of the barrier 16 that protrudes from the surface 12 may have an outer diameter of 20 mm or less or 15 mm or less or 10 mm or less or 5 mm or less. The part of the barrier 16 that protrudes from the surface 12 may have an outer diameter of 3 mm or more or 5 mm or more or 8 mm or more. The barrier 16 may have a height of 3 mm or more or 5 mm or more or 8 mm or more above the adjacent part of the surface 12 or sensors 14. Without the barrier 16, a commonly sized finger, for example a finger having a maximum width measured perpendicular to the finger thorough a portion of the finger having a nail of at least 15 mm, could contact or be close enough to trigger sensors or parts of a sensor on opposite sides of the interface 10.

The sensors 14 can be capacitance-based such that they detect the proximity of the finger to a sensor and do not require physical contact directly on the sensor. This also allows the sensors 14 to be embedded under a touch surface 18 over the sensors 14 which may be planar with or even integrated into the surface 12 (see for example FIG. 11), or the sensors 14 may be embedded under the barrier 16 which then functions as a touch surface (see for example FIG. 5) and the sensors 14 may be shaped differently than the touch surface 18 or barrier 16 itself. The sensors 14 could also be other than capacitance-based, for example comprising one or more sensitive tactile sensors or switches that activate when pressed by the user's finger. For further example, the sensors 14 may be a continuous sensor having a sensing surface covering a ring, cone or other suitable shape that outputs different voltages or other signals dependant on the circumferential (angular) placement of the user's finger along the surface.

The sensors 14 can be segmented into some number of parts, for example three or four or more, to provide physically separate sensing locations. Discrete detection of location is provided as the user's finger is placed in a segment and activates a sensor or sensor part in the segment. (See FIG. 7). When the user's finger makes contact with, or is in close proximity for example, to a segment, the corresponding sensor or sensor part activates, and the interface 10 recognizes that contact has been made.

In the example of FIGS. 1 to 10 there are four sensor segments 20 separated from adjacent sensor segments 20 by non-sensing segments 22. Absolute location of the user's finger in a segment can be reported from a sensor segment 20 to the remote control. Optionally, four additional locations of the finger, nominally located at 45 degrees of rotation from the centers of each segment, can be interpolated by detecting the simultaneous activation of adjacent sensor segment 20. (See FIG. 8) The travel of the user's finger through a sequence of segments 20 or interpolated locations or both can also be detected by the interface. Design of the barrier 16 and the size and spacing between sensor segments 20 generally prevents simultaneous triggering of more than two sensor segments 20 under normal usage. While two sensor segments 20 are sufficient to sense rotation and swipes in one direction, and three sensor segments 20 also allows detection of direction of rotation and (with interpolation between segments) swipes in two orthogonal directions, granularity of control generally increases with the number of segments 20 although at some point, perhaps at 6 or 8 segments 20, marginal increases in granularity from using more segments 20 may not be significant or cost effective. In the examples of the other figures, sensors 14 are segmented in that individual sensors function as described for the sensor segments 20 and the spaces between individual sensors function as the non-sensing segments 22.

Contacting and then releasing contact for one particular location or segment 20, without moving into another location or segment 20, can be interpreted as selection of a particular function. Circumferential (angular) spacing of two or more locations or segments 20 divides the interface into two or more functions. The locations or segments 20 can be used to indicate direction-based functions such as “forward” and “back” or simply discrete functions such as “select” and “menu”.

By moving the finger in an arc or circle around the center of the barrier 16, a rotation control intention can be communicated to the interface 10. (See for example FIG. 9). Rotation of the interface 10 can be in either direction around the barrier 16, for example clockwise or counter-clockwise. Angle of rotation around the center of the barrier 16 as well as direction and speed of rotation 16 can be measured and reported via the sensors 14. Rotation can continue beyond a full circle and can include multiple full circles. Absolute location can be used along with the rotation information to indicate rotation between two specific points.

The user's finger can indicate a swipe by moving generally radially through the center of the barrier 16 rather than angularly around the center of the barrier 16. For example, a swipe can be from one side of the barrier 16 to its opposite side over the top of the barrier 16 (see for example FIG. 10) rather than in an arcuate path around the center of the barrier 16 (as in for example FIG. 9). Detection of the swipe can be determined by a sequence of two signals from a segment 20 or location and then from a segment 20 or location on the opposite side of the barrier 16 without any intervening signals from other segments 20 or locations. The interface 10 can have an additional switch or other sensor, for example a capacitance or pressure sensor, located at the centre of the barrier 16 to further facilitate detection of this swipe path. In this case, a sequence of three signals from a segment 20 or location, then from the center of the barrier 16, and then from a segment 20 or location on the opposite side of the barrier 16 indicates a swipe. In this way, a rotational movement of the finger in which the finger was inadvertently lifted during a portion of the movement is not misinterpreted as a swipe. Further, if there is an intervening signal both from the center of the barrier 16 and a segment 20 of the sensors 14, the signal sequence can be interpreted as either a swipe or a rotation depending on which is more likely to have occurred given the configuration of the interface 10 or any other available information such as time of contact or pressure. For example, a fleeting contact with a segment 20 normal to the swipe can be ignored if longer contact with the central sensor (sensor at the center of the barrier 16) indicates a swipe. With or without the additional center sensor, accuracy can also be improved through analysis of the timing of (or between) contact of the user's finger with sensors on opposite sides of the barrier. For example, discrete detection of contact on opposite sides of the barrier within 500 ms can be determined to be a successful swipe. Contacts on opposite sides with more than 500 ms between contacts, but less than 2s could be ignored as spurious inputs. Contacts on opposite sides with more than 2s between contacts could be interpreted as two separate function presses.

A swipe-and-hold can be detected when the user's finger swipes from one side of the barrier to the opposite side of the barrier 16, but is then held in contact with the opposite side of the barrier 16 for some period of time. This can be interpreted as a request for a repeated action, or continuation of a scrolling function, or as a function different from the function indicated by the swipe. The direction of the swipe (for example front to back rather than back to front, or top to bottom rather than bottom to top) can be interpreted as requests for motions in opposite directions, or functions that are in some sense opposites of each other (for example, on and off or louder and softer). Swipes between top and bottom may correspond to different functions than swipes from side to side.

Alternately, and particularly if the interface 10 might be located at different angular orientations at different times, or if the user might not know the precise angular orientation of the interface 10, (both of which conditions can occur for example in an interface 10 located on a headset) a set of swipes might be interpreted as having the same meaning, or the meaning of a swipe might change in accordance with a reference direction. For example, a reference direction might be provided by gravity or a first or initializing swipe made by the user.

Used in a mouse or laptop design, the interface 10 can be placed on the top surface of the mouse, for example in the center of the finger click areas. The interface can detect a press of the “middle button”, swipe from top to bottom or vice versa to indicate vertical scrolling within a page, swipe from right to left to indicate horizontal scrolling within a page or going back in the browser history, swipe from left to right to go forward in the browser history, clockwise rotation to indicate zooming into on a page, and counter clockwise rotation to indicate zooming out of a page.

Used with an audio headset, the interface 10 can be placed on the outer surface of one of the headphones, for example in the center of one of the earpieces shown in U.S. Pat. No. 11/322,730, or on the single earpiece if there is only one, as shown for example in FIG. 22. The interface 10 can interpret a clockwise rotation as an increase in volume; a counter-clockwise rotation as a decrease in volume. If the headset controls a music player, a left-to-right swipe can be interpreted as skipping to the next track, and a right-to-left swipe as skipping to the last track; a left-to-right or right-to-left swipe-and-hold as seeking within a track. Pressing on the interface 10 may activate a switch in the center of the interface 10, or on parts of the interface other than the surface of the earpiece they are mounted on, can turn the headset or the music player on or off. Another interface may be located on another of the earpieces of the headphones to carry some of these functions or additional functions. Additional functions might include pausing or resuming music play, or answering or ending a telephone call, muting or un-muting a microphone or making a ‘push to talk’ radio communication.

Used in an audio, television or video player remote control, the interface 10 can be placed on the surface of a hand-held remote control. The interface can interpret rotation as volume control, side-to-side swipes and swipe-and-holds as track controls, up-and-down swipes as menu navigation controls, and taps as discrete functions such as “menu”, “select”, “exit”, etc.

The interface 10 is connected to hardware or software or both configured to receive signals from the interface 10, determine a function desired by the user considering the signals, and then communicate the function to a controlled device. Other inputs, for example clock signals, may also be considered.

FIG. 21 shows another interface 10 that is biased towards swiping inputs over rotational inputs. A touch surface 18 molded into a plastic enclosure 32 over a sensor ring 24 mounted on a PCB board 30 provides a barrier 16 in the shape of a truncated cone that is lower than the barriers 16 described above and shown in other Figures. The user positions their finger over the circumferential edge of the touch surface 18 with that edge roughly in the centre of their finger. Although there is less physical interference to guide a circular motion of the finger, the circumferential edge can still be followed by sense of touch. The center button 26 shown is optionally located over a tactile switch 28 and further optionally may be raised slightly in relation to the touch surface 18 to provide a compound shaped barrier 16.

In examples where the surface 12 is outside of and distinct from the touch surface 18 (or barrier 16), additional sensors or switches can be placed in the surface 12. For example, in the headset of FIG. 22, used to control an MP3 player such as an IPod™, surface 12a above the barrier 16 covers a tactile switch as does a surface 12b below the barrier 16. The surfaces 12a, 12b are spring biased outwards such that they can still support a finger contacting barrier 16 without activating the tactile switches, but the user can still press surfaces 12a, 12b with increased force to activate the tactile switches when desired. A similarly spring biased tactile switch is located under an assembly of the barrier 16 and sensors 14. Pressure on the center of the barrier 16 tells the MP3 player to pause or play. Pressure on surfaces 12a, 12b causes the MP3 player to skip forward or back to a song. Rotation around the barrier 16 increases or decreases volume.

1. A device having one or more sensors and a barrier wherein the one or more sensors have touch or proximity sensing areas on opposite sides of the barrier.

2. The device of claim 1 wherein the one or more sensors are concentric with the barrier.

3. The device of claim 1 wherein the outer diameter of its components, other than a surface separate or distinct from the barrier and sensors, is 20 mm or less, or 15 mm or less or 10 mm or less.

4. The device of claim 1 wherein the part of the barrier that protrudes from an adjacent surface has an outer diameter of 20 mm or less, or 15 mm or less or 10 mm or less.

5. The device of claim 1 wherein the barrier protrudes by at least 3 mm from the adjacent part of a surface surrounding it.

6. The device of claim 1 wherein the part of the barrier that protrudes from an adjacent surface has an outer diameter of 3 mm or less.

7. The device of claim 2 having at least three sensing areas dispersed around the axis of concentricity.

8. The device of claim 2 having a sensing area on the axis of concentricity.

9. The device of claim 1 further comprising software or hardware adapted to interpret signals from the sensors.

10. An interface or control device having one or more sensors and a barrier wherein the one or more sensors are arranged relative to the barrier to be able to detect touch or proximity of a finger on each of two opposite sides of the barrier, the barrier inhibits or provides a touch sensory indication of simultaneous touch or proximity of the finger to sensors or parts of the sensor on opposite sides of the barrier, and the size of the device is such that a finger could simultaneously touch or be near sensors or parts of a sensor on opposite sides of the device in normal use if the barrier were not present.
